(19) United States
(12) Patent Application Publication
(10) Pub. No.: US 2022/0382723 A1
(43) Pub. Date: Dec. 1, 2022

(54) SYSTEM AND METHOD FOR DEDUPLICATING DATA USING A MACHINE LEARNING MODEL TRAINED BASED ON TRANSFER LEARNING

(71) Applicant: VMWARE, INC., Palo Alto, CA (US)

(72) Inventors: KIRAN RAMA, Bangalore (IN); RAJEEV SHASTRI, Bangalore (IN)

(21) Appl. No.: 17/391,109

(22) Filed: Aug. 2, 2021

(30) Foreign Application Priority Data
May 26, 2021 (IN) 202141023438

(51) Int. Cl. G06F 16/215; G06N 3/04

(52) U.S. Cl. CPC G06F 16/215; G06N 3/0454

(57) ABSTRACT

A system and method for deduplicating target records using machine learning uses a deduplication machine learning model on the target records to classify the target records as duplicate target records and nonduplicate target records. The deduplication machine learning model leverages transfer learning, derived through first and second machine learning models for data matching, where the first machine learning model is trained using a generic dataset and the second machine learning model is trained using a target dataset and parameters transferred from the first machine learning model.

### RELATED APPLICATION

This application claims the benefit of Foreign Application Serial No. 202141023438 filed in India entitled “SYSTEM AND METHOD FOR DEDUPLICATING DATA USING A MACHINE LEARNING MODEL TRAINED BASED ON TRANSFER LEARNING”, on May 26, 2021, by VMWARE, Inc., which is herein incorporated in its entirety by reference for all purposes.

### BACKGROUND

Business-to-business (B2B) and business-to-consumer (B2C) companies can have hundreds of thousands of customers in their databases. Enterprises get customer data from various sources, such as sales, marketing, surveys, targeted advertisements, and references from existing customer. The customer data is typically entered using various front-end applications with human interventions. Multiple sources and multiple people involved in getting the customer data to the company master can create duplicate customer data.

Duplicate customer data can result in significant costs to organizations in lost sales due to ineffective targeting of customers, missed renewals due to unavailability of timely updated customer record, higher operational costs due to handling of duplicate customer accounts, and legal compliance issues due to misreported revenue and customer numbers to Wall Street. To solve these problems, companies employ automated data cleaning tools, such as tools from Trillium and SAP, to clean or remove duplicate data. In operation, when customer records are determined to be duplicates or nonduplicates with “high confidence” by the data cleaning tool, the duplicate records can be deduplicated. However, the remaining customer records, which have been processed by the data cleaning tool but have not been determined to be duplicates or nonduplicates with “high confidence”, must be manually examined by an operational team to determine whether there are any duplicate customer records.

Although conventional data cleaning tools work well for their intended purposes, they require manual examination for at least some of the customer data that cannot be positively determined to be duplicates or nonduplicates introduces significant labor cost and human error into the process. In addition, these manually labeled records usually need to be double checked before there is full confidence.

### SUMMARY

A system and method for deduplicating target records using machine learning uses a deduplication machine learning model on the target records to classify the target records as duplicate target records and nonduplicate target records. The deduplication machine learning model leverages transfer learning, derived through first and second machine learning models for data matching, where the first machine learning model is trained using a generic dataset and the second machine learning model is trained using a target dataset and parameters transferred from the first machine learning model.

A computer-implemented method for deduplicating target records using machine learning in accordance with an embodiment of the invention comprises training a first machine learning model for data matching using a generic dataset, saving trained parameters of the first machine learning model, the trained parameters representing knowledge gained during the training of the first machine learning model for data matching, transferring the trained parameters of the first machine learning model to a second machine learning model, training the second machine learning model with the trained parameters for data matching using a target dataset to derive a deduplication machine learning model, and applying the deduplication machine learning model on the target records to classify the target records as duplicate target records and nonduplicate target records. In some embodiments, the steps of this method are performed when program instructions contained in a non-transitory computer-readable storage medium are executed by one or more processors.

A system for deduplicating target records using machine learning comprises memory and at least one processor configured to train a first machine learning model for data matching using a generic dataset, save trained parameters of the first machine learning model, the trained parameters representing knowledge gained during the training of the first machine learning model for data matching, transfer the trained parameters of the first machine learning model to a second machine learning model, train the second machine learning model with the trained parameters for data matching using a target dataset to derive a deduplication machine learning model, and apply the deduplication machine learning model on the target records to classify the target records as duplicate target records and nonduplicate target records.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a deduplication system in accordance with an embodiment of the invention.

FIG. 2 is a block diagram of a model training system in accordance with an embodiment of the invention.

FIG. 3 is a process flow diagram of an operation for building a deduplication machine learning (ML) model that is executed by the model training system in accordance with an embodiment of the invention.

FIG. 4 is a graphical illustration of how first and second deep neural networks are trained to derive the deduplication ML model in accordance with an embodiment of the invention.

FIG. 5 is a process flow diagram of a deduplication operation that is executed by the deduplication system using the deduplication ML model built using the model training system in accordance with an embodiment of the invention.

FIG. 6A is a block diagram of a multi-cloud computing system in which the deduplication system and/or the model training system may be implemented in accordance with an embodiment of the invention.

FIG. 6B shows an example of a private cloud computing environment that may be included in the multi-cloud computing system of FIG. 6A.

FIG. 6C shows an example of a public cloud computing environment that may be included in the multi-cloud computing system of FIG. 6A.

FIG. 7 is a flow diagram of a computer-implemented method for deduplicating target records using machine learning in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

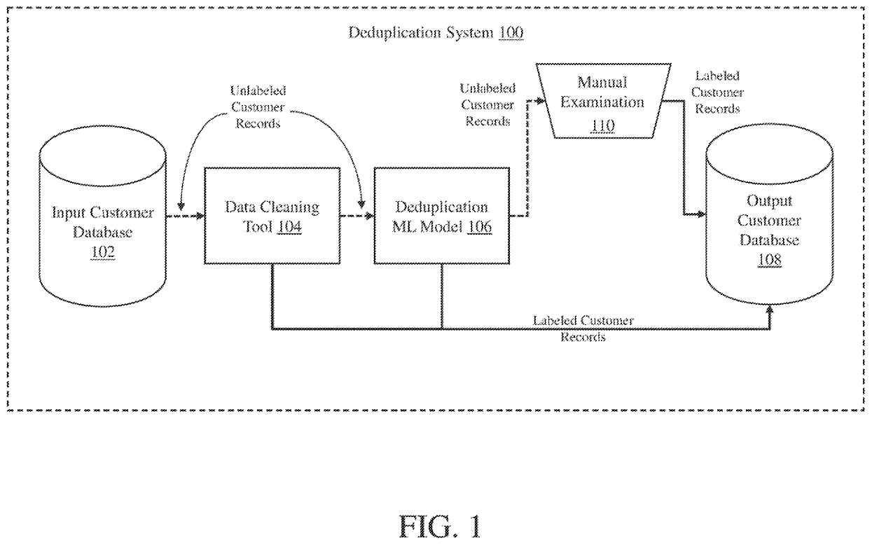

FIG. 1 shows a deduplication system 100 in accordance with an embodiment of the invention. The deduplication system 100 includes an input customer database 102, a data cleaning tool 104, a deduplication machine learning (ML) model 106, and an output customer database 108. The data cleaning tool 104 and the deduplication ML model 106 operate in series to automatically classify a significant portion of customer records from the input customer database 102 as either duplicate customer records or nonduplicate customer records with a high degree of confidence, which are then stored in the output customer database 108. The data cleaning tool 104 is designed to first process the input customer records to automatically classify a portion of the input customer records as either duplicate customer records or nonduplicate customer records with a high degree of confidence. The deduplication ML model 106 is designed to further process the input customer records that were not determined to be either duplicate or nonduplicate customer records with a high degree of confidence by the data cleaning tool 104. In particular, the deduplication ML model 106 uses machine learning to automatically classify additional portion of the input customer records as either duplicate customer records or nonduplicate customer records with a high degree of confidence. A small remaining portion of the input customer records that cannot be determined to be either duplicate or nonduplicate customer records with a high degree of confidence by both the data cleaning tool 104 and the deduplication ML model 106 can be processed using a manual examination process 110, which can be performed by an operational team to manually determine whether these remaining customer records are duplicates or nonduplicate customer records. The addition of the deduplication ML model 106 in the deduplication system 100 significantly reduces the amount of customer records that need to be manually examined, which translates into reduced labor cost, reduction of human errors and faster processing time.

The input customer database 102 includes the customer records that needs to be processed by the deduplication system 100. In some embodiments, the input customer database 102 may be part of the master database of an enterprise or a business entity. Each customer record includes name of the customer of the enterprise or business entity and other customer information, such as customer address, which may include street, city, state, zip code and/or country. The input customer database 102 may include whitespace customer records, which is data of customers that have never purchased in the past, in addition to new customer records for existing customers. The customer records may be entered into the input customer database 102 from multiple sources, such as sales, marketing, surveys, targeted advertisement, and references from existing customers using various front-end applications. Duplicate customer records occur more prominently for whitespace customer records, but can also occur for existing custom records. For example, IBM may be entered by an order management personnel as IBM, International Business Machines, IBM Bulgaria, Intl Biz Machines or other related names.

The data cleaning tool 104 operates to process the customer records from the input customer database 102 to find duplicate customer records using predefined rules for data matching so that the duplicate customer records can be consolidated, which may involve deleting or renaming duplicate customer records. Specifically, the data cleaning tool 104 determines whether customer records are duplicate customer records with a high degree of confidence or nonduplicate customer records with a high degree of confidence. The degree of confidence for a determination of duplicate or nonduplicate customer records may be provided as a numerical value or a percentage, which can be viewed as being a confidence probability score. Thus, a high degree of confidence can be defined as a confidence probability score greater than a threshold. The customer records that have been determined to be duplicate or nonduplicate customer records with a high degree of confidence by the data cleaning tool 104 can be viewed as being labeled as duplicate or nonduplicate customer records. Thus, these customer records will be referred to herein as “labeled” customer records. As illustrated in FIG. 1, the “labeled” customer records from the data cleaning tool 104 are transmitted to and stored in the output customer database 108, which may be the master database for the enterprise that owns and/or operates the deduplication system 100. The remaining customer records that cannot be determined to be either duplicate customer records or nonduplicate customer records with a high degree of confidence by the data cleaning tool 104, i.e., the “unlabeled” customer records, are transmitted to the deduplication ML model 106 for further processing.

In an embodiment, the data cleaning tool 104 may be a data cleaning tool that is commercially available. As an example, the data cleaning tool 104 may be a data cleaning tool from Trillium or SAP. The data cleaning tool 104 may be part of a data storage solution that manages storage of data for enterprises. The data cleaning tool 104 may be implemented as software running in a computing environment, such as an on-premises data center and/or a public cloud computing environment.

Conventionally, all the “unlabeled” customer records from the data cleaning tool 104 would have to be manually examined by an operational team to determine whether these “unlabeled” customer records are duplicate or nonduplicate customer records. Since there can be a significant number of “unlabeled” customer records from the data cleaning tool 104, the costs associated with the manual examination of these “unlabeled” customer records can be high. The deduplication system 100 reduces these costs by using the deduplication ML model 106 to further reduce the number of “unlabeled” customer records that need to be manually examined.

The deduplication ML model 106 operates to use machine learning to process the “unlabeled” customer records, which were output from the data cleaning tool 104, to determine whether these “unlabeled” customer records are either duplicate customer records with a high degree of confidence or nonduplicate customer records with a high degree of confidence. Thus, some “unlabeled” customer records from the data cleaning tool 104 are converted to “labeled” customer records by the deduplication ML model 106. The degree of confidence for a determination of duplicate or nonduplicate customer records by the deduplication ML model 106 may be provided as a numerical value or a percentage, which can be viewed as being a machine learning confidence probability score. Thus, a high degree of confidence can be defined as a machine learning confidence probability score greater than a threshold. In some embodiments, the deduplication ML model 106 is a deep neural network (DNN). However, in other embodiments, the deduplication ML model 106 may be a different machine learning model. As described in detail below, the deduplication ML model 106 is trained using transfer learning, which involves saving knowledge gained from training a machine learning model using a noncustomer record dataset, i.e., a dataset that does not contain customer records, and applying the knowledge to another machine learning model to produce the deduplication ML model 106, which has better performance than a machine learning model just trained on a limited dataset of customer records.

The previous “unlabeled” customer records from the data cleaning tool 104 that are determined by the deduplication ML model 106 to be either duplicate customer records or nonduplicate customer records with a high degree of confidence, i.e., current “labeled” customer records, are transmitted to and stored in the output customer database 108. The remaining customer records that cannot be determined to be either duplicate customer records or nonduplicate customer records with a high degree of confidence by the deduplication ML model 106, i.e., the “unlabeled” customer records, are further processed using the manual examination process 110. Once the “unlabeled” customer records are manually determined to be duplicate customer records or nonduplicate customer records, these customer records can also be stored in the output customer database 108.

In the deduplication system 100, since the deduplication ML model 106 takes as input the “unlabeled” customer records from the data cleaning tool 104 and converts at least some of them to “labeled” customer records, the amount of customer records that must be manually processed is meaningfully reduced. As a result, fewer “unlabeled” customer records need to be manually examined, which significantly reduces the labor cost associated with the manual examination of these “unlabeled” customer records. In addition, with fewer customer records being manually examined, human errors involved in the manual examination of these “unlabeled” customer records may also be reduced.

Transfer learning as a concept has been used in computer vision and natural language processing (NLP). The idea in transfer learning in computer vision or NLP (Natural Language Processing) is to achieve state-of-the-art accuracy on a new task from a machine learning model trained on a totally unrelated task. As an example, transfer learning has been used to achieve state-of-the-art performance on tasks such as learning to distinguish human images using a deep neural network (DNN) that has been trained on an unrelated task of classifying dog images from cat images or classifying dog images from ImageNet images. As explained below, a variant of this approach has been applied to a totally unrelated field of data matching to train the deduplication ML model 106, which may be derived using a combination of deep learning, transfer learning and unrelated datasets to the field of data matching.

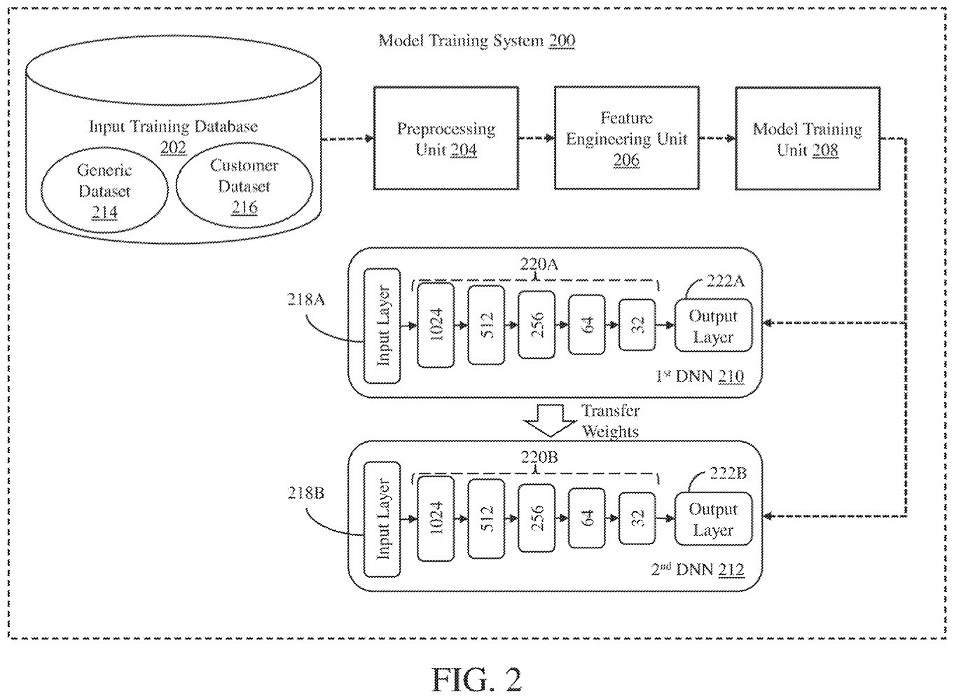

FIG. 2 shows a model training system 200 that can be used to produce the deduplication ML model 106 in accordance with an embodiment of the invention. The model training system 200 includes an input training database 202, a preprocessing unit 204, a feature engineering unit 206 and a model training unit 208. In this embodiment, the model training system 200 will be described as a system that trains DNNs, including a first DNN 210 and a second DNN 212. However, in other embodiments, the model training system 200 may be configured to train other types of machine learning models. In some embodiments, these components of the model training system 200 may be implemented as software running in one or more computing systems, which may include an on-premises data center and/or a public cloud computing environment.

The input training database 202 of the model training system 200 includes at least a training generic dataset 214 of noncustomer records and a training customer dataset 216 of customer records. The training generic dataset 214 may include records that are unrelated to customer records, such as baby names, voter records and organization affiliation records, which may or may not include addresses in addition to names. The training customer dataset 216 includes customer records, which may be existing customer records of a single enterprise.

The preprocessing unit 204 of the model training system 200 operates to perform one or more text preprocessing steps on one or more training datasets from the input training database 202 to ensure that the training datasets can be properly used for neural network training. These text preprocessing steps may include known text processing steps, such as abbreviation encoding, special character removal, stop word removal, punctuation removal and root word/stemming treatment, which are executed if and where applicable.

The feature engineering unit 206 of the model training system 200 operates to perform one or more text feature extraction steps on each training dataset from the input training database 102 to output features that can be used for neural network training. These feature engineering steps may involve known feature extraction processes. In some embodiments, the processes performed by the feature engineering unit 206 involves three types of features derived out of strings, which include edit distance features (e.g., Hamming, Levenshtein and Longest Common Substring etc.), Q-gram based distance features (e.g., Jaccard and cosine) and string length on various features. In an embodiment, these features or metrics are computed for all possible combination of name, address and country, which define geographic features. Along with the string distances, term frequency-inverse document frequency (TF-IDF) and word embeddings may be computed to add features related to semantic similarity and word importance.

The model training unit 208 of the model training system 200 operates to train DNNs using the input training datasets and the extracted features to obtain parameters for the DNNs. These parameters for the DNNs include, but not limited to, weights and bias used in the hidden layers of the DNNs being trained. In particular, the model training unit 208 can apply transfer learning to train at least some DNNs using knowledge gained from training other DNNs. As an example, as illustrated in FIG. 2, the model training unit 208 can train the first DNN 210 on the training generic dataset 214, which may be completely unrelated to company customer records, and can then train the second DNN 212 on the training customer dataset 216 using transfer learning from the first DNN. Specifically, the weights used in the hidden layers of the trained first DNN 210 can be transferred to the second DNN 212 during the training process of the second DNN, as explained in more detail below.

The first DNN 210 that is trained by the model training unit 208 includes an input layer 218A, one or more hidden layers 220A and an output layer 222A. In the illustrated embodiment, the first DNN 210 includes five (5) hidden layers 220A with dimensions 1024, 512, 256, 64 and 32, respectively, from the input layer 218A to the output layer 222A. The input layer 218A takes input data and passes the data to the first hidden layers 220A. Each of the hidden layers 220A performs an affine transformation followed by rectified linear unit (ReLU) activation function, dropout and batch normalization. The initial hidden layers of first DNN 210, e.g., the first three (3) hidden layers, learn the simple features of the strings and the subsequent layers, e.g., the last two (2) hidden layers, learn complex features specific to the network and on the specialized task. The output layer performs a softmax function to produce the final results. The DNN equation for the first DNN 210 is defined by the number of hidden layers, the weights and the biases of the hidden layers. If the first DNN 210 has three (3) hidden layers, where the weights are given by W1, W2 and W3 and the biases are given by b1, b2 and b3, the DNN equation is as follows:

f(x)=σ(W3*ReLU(W2*(ReLU(W1*x+b1))+b2)+b3),

where σ is the sigmoid activation function with the form

σ(x)=1/(1+e^{-x}),

and ReLU is the ReLU activation function with the form

ReLU(x)=x if x≥0, else 0.

The second DNN 212 that is trained by the model training unit 208 includes an input layer 218B, one or more hidden layers 220B and an output layer 222B, which are similar to the corresponding layers of the first DNN 210. In an embodiment, the second DNN 212 is identical to the first DNN 210, as illustrated in FIG. 2, except for the parameters used in the second DNN, such as the weights and biases used in the hidden layers 220B. Thus, in this embodiment, the second DNN 212 also includes five (5) hidden layers. The second DNN 212 is trained to be the deduplication ML model 106, which can be used in the deduplication system 100. In particular, transfer learning is used to train the second DNN 212 to take advantage of knowledge gained during the training of the first DNN 210 using the training generic dataset 214, which is significantly larger than the training customer dataset 216. This is extremely useful in the real-world where there may not be enough labeled examples for the specific task. Additionally, manual labeling can be a costly exercise in terms of costs, resources and time. This knowledge from the training of the first DNN 210 includes the weights used in the hidden layers 220A of the first DNN, which are saved and transferred to the second DNN 212. Thus, instead of training the second DNN 212 on the training customer dataset 216 to derive the weights for the hidden layers 220B of the second DNN, the initial layer weights of the first DNN 210 are transferred to the second DNN 212. Thus, knowledge gained from training on the training generic dataset 214 is transferred to the second DNN 212, which allows the second DNN to learn the factors that determine name matches from the training generic dataset and extrapolate the learning to customer records.

The second DNN 212 is then further trained on the training customer dataset 216 using the transferred knowledge, e.g., hidden layer weights, from the first DNN 210. In some embodiments, the hidden layers of the second DNN 212 with the weights transferred from the first DNN 210 are frozen and the remaining hidden layers of the second DNN are trained on the training customer dataset 216. When the performance of the second DNN 210 is sufficiently adequate, the frozen hidden layers of the second DNN are unfrozen and the whole DNN is trained again for even superior performance. This means that the final layers of the first DNN 210 built on the training generic dataset 214, which may include baby names and organization affiliation names, are fine tuned in the second DNN 212 to work well on the training customer dataset 216, which include customer names. In an embodiment, when the frozen layers of the second DNN 212 are unfrozen, the second DNN is trained again with a slower learning rate to improve the performance of the second DNN. Thus, the idea for training the second DNN in the manner described above is to fine-tune the model learnt on a large generic dataset, to work on the much smaller dataset through transfer learning.

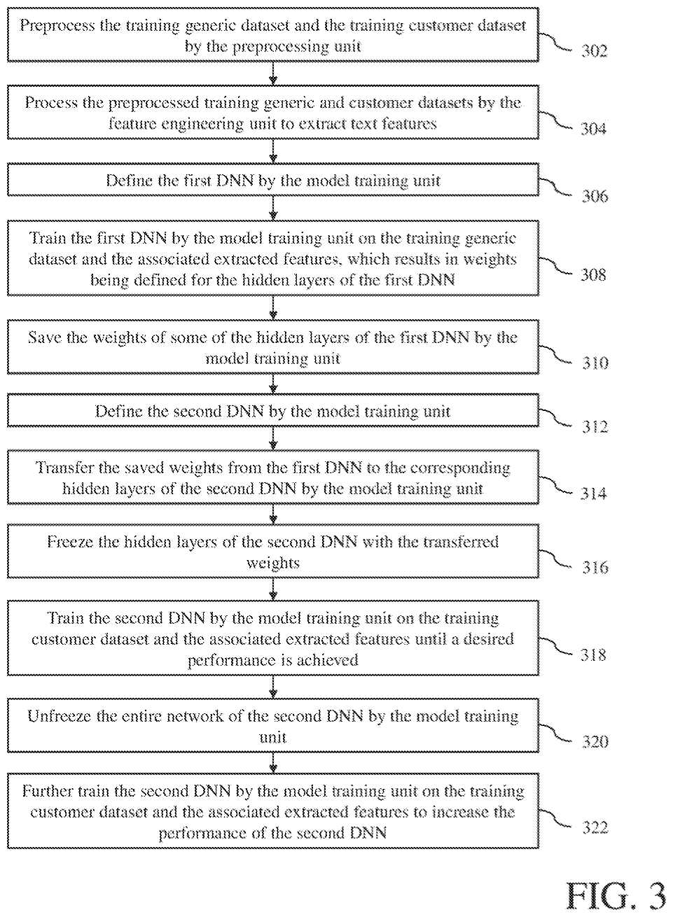

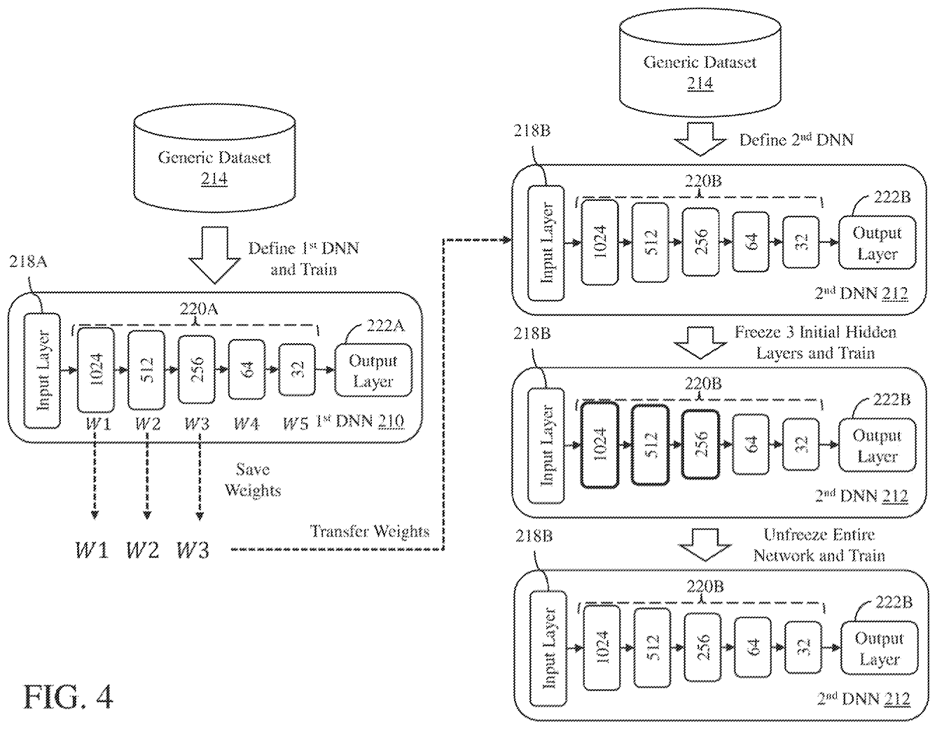

FIG. 3 shows a process flow diagram of an operation for building the deduplication ML model 106 that is executed by the model training system 200 in accordance with an embodiment of the invention. This operation is described with references to FIG. 4, which is a graphical illustration of how the first and second DNNs 210 and 212 are trained to derive the deduplication ML model 106. The operation begins at step 302, where the training generic dataset 214 and the training customer dataset 216 are preprocessed by the preprocessing unit 204. The training generic dataset 214 is significantly larger dataset than the training customer dataset 216. The preprocessing executed by the preprocessing unit 204 may include one or more known text processing steps, such as abbreviation encoding, special character removal, stop word removal, punctuation removal and root word/stemming treatment.

Next, at step 304, the preprocessed training generic dataset 214 and the preprocessed training customer dataset 216 are processed by the feature engineering unit 206 to extract text features. The text features extracted by the feature engineering unit 206 may include one or more edit distance features, Q-gram distance features, string lengths on various features, and features related to semantic similarity and word importance.

Next, at step 306, the first DNN 210 is defined by the model training unit 208. As an example, the first DNN 210 may be defined to have the input layer 218A, the five (5) hidden layers 220A and the output layer 222A, as illustrated in FIG. 4.

Next, at step 308, the first DNN 210 is trained by the model training unit 208 on the training generic dataset 214 and the associated extracted features, which results in weights being defined for the hidden layers 220A of the first DNN 210. In the example illustrated in FIG. 4, the number of weights that are defined will be five (5) weights, which are W1, W2, W3, W4 and W5, one for each of the hidden layers 220A of the first DNN 210.

Next, step 310, the weights of some of the hidden layers 220A of the first DNN 210 are saved by the model training unit 208. In an embodiment, the weights of one or more of the initial hidden layers 220A of the first DNN 210 are saved. Thus, the weight(s) of one or more remaining hidden layers 220A of the first DNN 210 are not saved. In the example illustrated in FIG. 4, the weights of the first three hidden layers 220A of the first DNN 210 are saved. Thus, in this example, the weights W1, W 2 and W3 from the trained first DNN 210 are saved. In some embodiments, the biases of the same hidden layers 220A of the first DNN 210 may also be saved.

Next, at step 312, the second DNN 212 is defined by the model training unit 208. The second DNN 212 may be defined to have the same model architecture as the first DNN 210. In the example illustrated in FIG. 4, the second DNN 212 is also defined to have one input layer 218B, five (5) hidden layers 220B and one output layer 222B.

Next, at step 314, the saved weights from the first DNN 210 are transferred to the corresponding hidden layers 220B of the second DNN 212 by the model training unit 208. In the example illustrated in FIG. 4, the saved weights W1, W2 and W3 of the first three (3) hidden layers 220A of the first DNN 210 are transferred to the corresponding first three (3) hidden layers 220B of the second DNN 212. In some embodiments where the biases were also saved, the saved biases may also be transferred to the corresponding hidden layers 220B of the second DNN 212.

Next, at step 316, the hidden layers 220B of the second DNN 212 with the transferred weights are frozen. Thus, at least one of the hidden layers 220B of the second DNN 212 is not frozen. In some embodiments, one or more initial hidden layers 220B of the second DNN 212 may be frozen. In the example illustrated in FIG. 4, the first three (3) hidden layers 220B of the second DNN 212 with the transferred weights W1, W 2 and W3 are frozen.

Next, at step 318, the second DNN 212 is trained by the model training unit 208 on the training customer dataset 216 and the associated extracted features until a desired performance is achieved. Next, at step 320, the entire network of the second DNN 212 is unfrozen by the model training unit 208. In other words, each frozen hidden layer 220B of the second DNN 212 is unfrozen so that all the hidden layers of the second DNN are unfrozen. In the example illustrated in FIG. 4, the first three (3) hidden layers 220B of the second DNN 212 are unfrozen.

Next, at step 322, the second DNN 212 is further trained by the model training unit 208 on the training customer dataset 216 and the associated extracted features to increase the performance of the second DNN. In some embodiments, the second DNN 212 may be trained using a slower rate. The resulting trained second DNN 212 is the deduplication ML model 106, which can be used in the deduplication system 100. The described technique for training the second DNN 212 is extremely useful when the actual data size is small, as the model can leverage learning from the larger dataset.

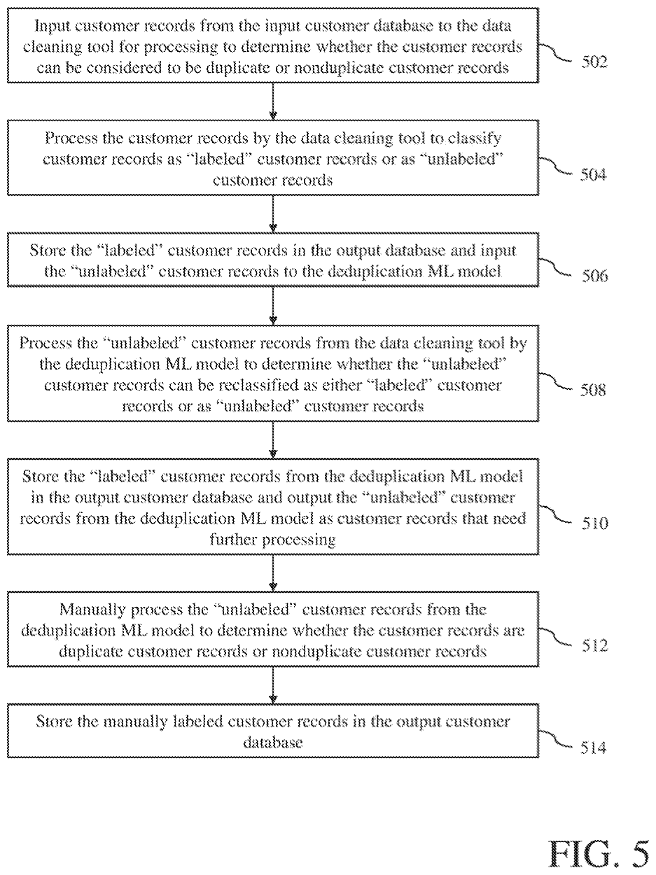

FIG. 5 shows a process flow diagram of a deduplication operation that is executed by the deduplication system 100 using the deduplication ML model 106 built using the model training system 200 in accordance with an embodiment of the invention. The operation begins at step 502, where customer records from the input customer database 102 are input to the data cleaning tool 104 for processing to determine whether the customer records can be considered to be duplicate or nonduplicate customer records. In some embodiments, the customer records may include only new customer records that were entered during a recent period of time into the database 102, which may or may not be part of the master database of an enterprise. In other embodiments, the customer records include both new customer records and existing customer records in the database 102.

Next, at step 504, the customer records are processed by the data cleaning tool 104 to classify customer records as “labeled” customer records or as “unlabeled” customer records. As noted above, the “labeled” customer records are customer records that have been classified as either duplicate or nonduplicate customer records with a high degree of confidence. The “unlabeled” customer records are customer records that could not be classified as either duplicate or nonduplicate customer records with a high degree of confidence.

Next, at step 506, the “labeled” customer records are stored in the output database 108 and the “unlabeled” customer records are input to the deduplication ML model 106. In some embodiments, only the “labeled” customer records that have been determined to be nonduplicate customer records may be stored in the output database 108. In other embodiments, both the duplicate and nonduplicate “labeled” customer records may be stored in the output database 108, and may be further processed, e.g., to purge the duplicate customer records.

Next, at step 508, the “unlabeled” customer records from the data cleaning tool 104 are processed by the deduplication ML model 106 to determine whether the “unlabeled” customer records can be reclassified as either “labeled” customer records or as “unlabeled” customer records. Similar to the data cleaning tool 104, the customer records that are determined to be “labeled” customer records by the deduplication ML model 106 are customer records that have been classified as either duplicate or nonduplicate customer records with a high degree of confidence, which may be same or different from the high degree of confidence used by the data cleaning tool 104. The customer records that are determined to be “unlabeled” customer records by the deduplication ML model 106 are customer records that could not be classified as either duplicate or nonduplicate customer records with the same high degree of confidence.

Next, at step 510, the “labeled” customer records from the deduplication ML model 106 are stored in the output customer database 108 and the “unlabeled” customer records from the deduplication ML model 106 are output as customer records that need further processing. Similar to the “labeled” customer records from the data cleaning tool 104, in some embodiments, only the “labeled” customer records from the deduplication ML model 106 that have been determined to be nonduplicate customer records may be stored in the output customer database 108. In other embodiments, both the duplicate and nonduplicate “labeled” customer records from the deduplication ML model 106 may be stored in the output customer database 108, and may be further processed, e.g., to purge the duplicate customer records.

Next, at step 512, the “unlabeled” customer records from the deduplication ML model 106 are manually processed to determine whether the customer records are duplicate customer records or nonduplicate customer records. Next, at step 514, the manually labeled customer records are stored in the output customer database 108. In some embodiments, only the customer records that have been determined to be nonduplicate customer records may be stored in the output customer database 108. In other embodiments, both the duplicate and nonduplicate customer records may be stored in the output customer database 108, and may be further processed, e.g., to purge the duplicate customer records.

In the embodiments described herein, the records that are processed by the deduplication system 100 and the model training system 200 are customer records. However, in other embodiments, the records that are processed by the deduplication system 100 and the model training system 200 may be any records that may require deduplication.

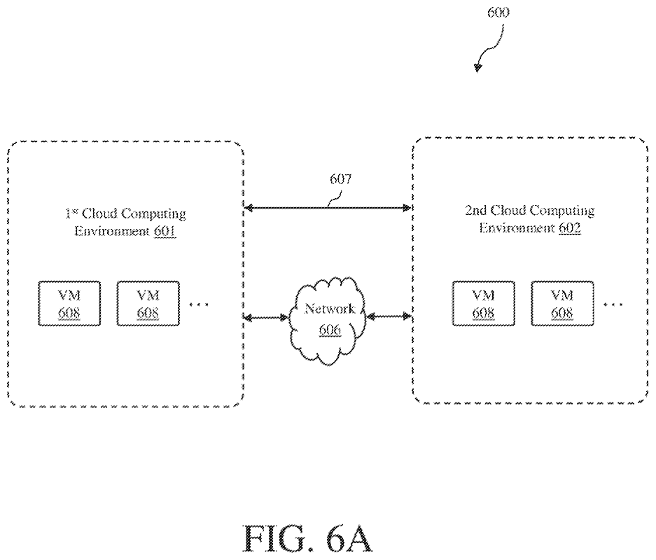

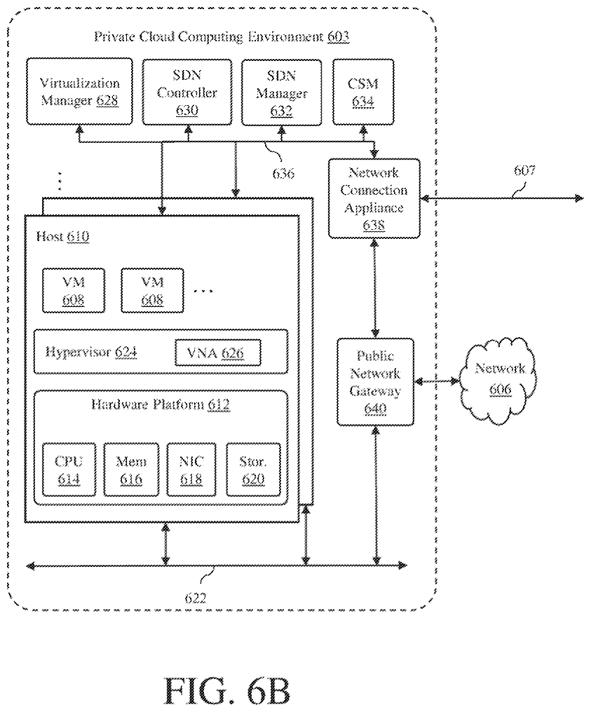

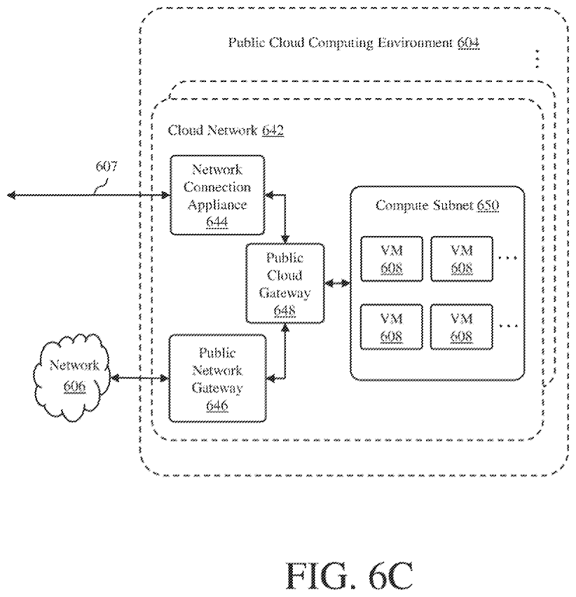

Turning now to FIG. 6A, a multi-cloud computing system 600 in which the deduplication system 100 and/or the model training system 200 may be implemented in accordance with an embodiment of the invention is shown. The computing system 600 includes at least a first cloud computing environment 601 and a second cloud computing environment 602, which may be connected to each other via a network 606 or a direction connection 607. The multi-cloud computing system is configured to provide a common platform for managing and executing workloads seamlessly between the first and second cloud computing environments. In an embodiment, the first and second cloud computing environments may both be private cloud computing environments to form a private-to-private cloud computing system. In another embodiment, the first and second cloud computing environments may both be public cloud computing environments to form a public-to-public cloud computing system. In still another embodiment, one of the first and second cloud computing environments may be a private cloud computing environment and the other may be a public cloud computing environment to form a private-to-public cloud computing system. In some embodiments, the private cloud computing environment may be controlled and administrated by a particular enterprise or business organization, while the public cloud computing environment may be operated by a cloud computing service provider and exposed as a service available to account holders or tenants, such as the particular enterprise in addition to other enterprises. In some embodiments, the private cloud computing environment may comprise one or more on-premises data centers.

The first and second cloud computing environments 601 and 602 of the multi-cloud computing system 600 include computing and/or storage infrastructures to support a number of virtual computing instances 608. As used herein, the term “virtual computing instance” refers to any software entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being VMs, although embodiments of the invention described herein are not limited to VMs. These VMs running in the first and second cloud computing environments may be used to implement the deduplication system 100 and/or the model training system 200.

An example of a private cloud computing environment 603 that may be included in the multi-cloud computing system 600 in some embodiments is illustrated in FIG. 6B. As shown in FIG. 6B, the private cloud computing environment 603 includes one or more host computer systems (“hosts”) 610. The hosts may be constructed on a server grade hardware platform 612, such as an x86 architecture platform. As shown, the hardware platform of each host may include conventional components of a computing device, such as one or more processors (e.g., CPUs) 614, memory 616, a network interface 618, and storage 620. The processor 614 can be any type of a processor, such as a central processing unit. The memory 616 is volatile memory used for retrieving programs and processing data. The memory 616 may include, for example, one or more random access memory (RAM) modules. The network interface 618 enables the host 610 to communicate with another device via a communication medium, such as a physical network 622 within the private cloud computing environment 603. The physical network 622 may include physical hubs, physical switches and/or physical routers that interconnect the hosts 610 and other components in the private cloud computing environment 603. The network interface 618 may be one or more network adapters, such as a Network Interface Card (NIC). The storage 620 represents local storage devices (e.g., one or more hard disks, flash memory modules, solid state disks and optical disks) and/or a storage interface that enables the host 610 to communicate with one or more network data storage systems. Example of a storage interface is a host bus adapter (HBA) that couples the host 610 to one or more storage arrays, such as a storage area network (SAN) or a network-attached storage (NAS), as well as other network data storage systems. The storage 620 is used to store information, such as executable instructions, virtual disks, configurations and other data, which can be retrieved by the host 610.

Each host 610 may be configured to provide a virtualization layer that abstracts processor, memory, storage and networking resources of the hardware platform 612 into the virtual computing instances, e.g., the VMs 608, that run concurrently on the same host. The VMs run on top of a software interface layer, which is referred to herein as a hypervisor 624, that enables sharing of the hardware resources of the host by the VMs. These VMs may be used to execute various workloads. Thus, these VMs may be used to implement the deduplication system 100 and/or the model training system 200.

One example of the hypervisor 624 that may be used in an embodiment described herein is a VMware ESXi™ hypervisor provided as part of the VMware vSphere® solution made commercially available from VMware, Inc. The hypervisor 624 may run on top of the operating system of the host or directly on hardware components of the host. For other types of virtual computing instances, the host 610 may include other virtualization software platforms to support those processing entities, such as Docker virtualization platform to support software containers. In the illustrated embodiment, the host 610 also includes a virtual network agent 626. The virtual network agent 626 operates with the hypervisor 624 to provide virtual networking capabilities, such as bridging, L3 routing, L2 Switching and firewall capabilities, so that software defined networks or virtual networks can be created. The virtual network agent 626 may be part of a VMware NSX° logical network product installed in the host 610 (“VMware NSX” is a trademark of VMware, Inc.). In a particular implementation, the virtual network agent 626 may be a virtual extensible local area network (VXLAN) endpoint device (VTEP) that operates to execute operations with respect to encapsulation and decapsulation of packets to support a VXLAN backed overlay network.

The private cloud computing environment 603 includes a virtualization manager 628, a software-defined network (SDN) controller 630, an SDN manager 632, and a cloud service manager (CSM) 634 that communicate with the hosts 610 via a management network 636. In an embodiment, these management components are implemented as computer programs that reside and execute in one or more computer systems, such as the hosts 610, or in one or more virtual computing instances, such as the VMs 608 running on the hosts.

The virtualization manager 628 is configured to carry out administrative tasks for the private cloud computing environment 602, including managing the hosts 610, managing the VMs 608 running on the hosts, provisioning new VMs, migrating the VMs from one host to another host, and load balancing between the hosts. One example of the virtualization manager 628 is the VMware vCenter Server® product made available from VMware, Inc.

The SDN manager 632 is configured to provide a graphical user interface (GUI) and REST APIs for creating, configuring, and monitoring SDN components, such as logical switches, and edge services gateways. The SDN manager allows configuration and orchestration of logical network components for logical switching and routing, networking and edge services, and security services and distributed firewall (DFW). One example of the SDN manager is the NSX manager of VMware NSX product.

The SDN controller 630 is a distributed state management system that controls virtual networks and overlay transport tunnels. In an embodiment, the SDN controller is deployed as a cluster of highly available virtual appliances that are responsible for the programmatic deployment of virtual networks across the multi-cloud computing system 600. The SDN controller is responsible for providing configuration to other SDN components, such as the logical switches, logical routers, and edge devices. One example of the SDN controller is the NSX controller of VMware NSX product.

The CSM 634 is configured to provide a graphical user interface (GUI) and REST APIs for onboarding, configuring, and monitoring an inventory of public cloud constructs, such as VMs in a public cloud computing environment. In an embodiment, the CSM is implemented as a virtual appliance running in any computer system. One example of the CSM is the CSM of VMware NSX product.

The private cloud computing environment 603 further includes a network connection appliance 638 and a public network gateway 640. The network connection appliance allows the private cloud computing environment to connect another cloud computing environment through the direct connection 607, which may be a VPN, Amazon Web Services® (AWS) Direct Connect or Microsoft® Azure® ExpressRoute connection. The public network gateway allows the private cloud computing environment to connect to another cloud computing environment through the network 606, which may include the Internet. The public network gateway may manage external public Internet Protocol (IP) addresses for network components in the private cloud computing environment, route traffic incoming to and outgoing from the private cloud computing environment and provide networking services, such as firewalls, network address translation (NAT), and dynamic host configuration protocol (DHCP). In some embodiments, the private cloud computing environment may include only the network connection appliance or the public network gateway.

An example of a public cloud computing environment 604 that may be included in the multi-cloud computing system 600 in some embodiments is illustrated in FIG. 6C. The public cloud computing environment 604 is configured to dynamically provide cloud networks 642 in which various network and compute components can be deployed. These cloud networks 642 can be provided to various tenants, which may be business enterprises. As an example, the public cloud computing environment may be AWS cloud and the cloud networks may be virtual public clouds. As another example, the public cloud computing environment may be Azure cloud and the cloud networks may be virtual networks (VNets).

The cloud network 642 includes a network connection appliance 644, a public network gateway 646, a public cloud gateway 648 and one or more compute subnetworks 650. The network connection appliance 644 is similar to the network connection appliance 638. Thus, the network connection appliance 644 allows the cloud network 642 in the public cloud computing environment 604 to connect to another cloud computing environment through the direct connection 607, which may be a VPN, AWS Direct Connect or Azure ExpressRoute connection. The public network gateway 646 is similar to the public network gateway 640. The public network gateway 646 allows the cloud network to connect to another cloud computing environment through the network 606. The public network gateway 646 may manage external public IP addresses for network components in the cloud network, route traffic incoming to and outgoing from the cloud network and provide networking services, such as firewalls, NAT and DHCP. In some embodiments, the cloud network may include only the network connection appliance 644 or the public network gateway 646.

The public cloud gateway 648 of the cloud network 642 is connected to the network connection appliance 644 and the public network gateway 646 to route data traffic from and to the compute subnets 650 of the cloud network via the network connection appliance 644 or the public network gateway 646.

The compute subnets 650 include virtual computing instances (VCIs), such as VMs 608. These VMs run on hardware infrastructure provided by the public cloud computing environment 604, and may be used to execute various workloads. Thus, these VMs may be used to implement the deduplication system 100 and/or the model training system 200.

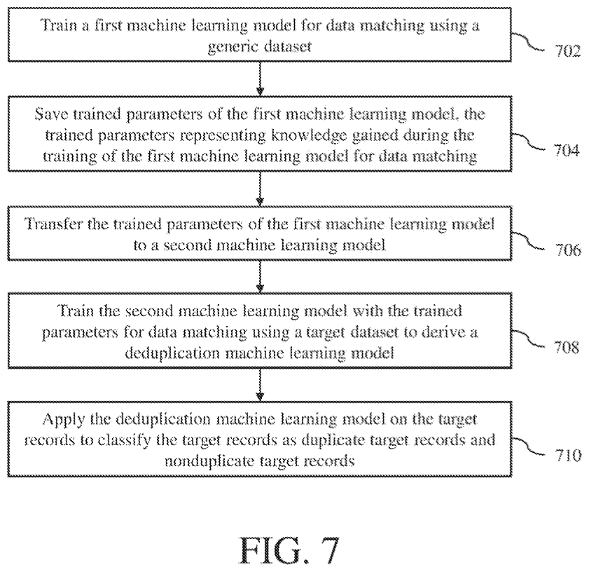

A computer-implemented method for deduplicating target records using machine learning in accordance with an embodiment of the invention is described with reference to a flow diagram of FIG. 7. At block 702, a first machine learning model is trained for data matching using a generic dataset. At block 704, trained parameters of the first machine learning model are saved. The trained parameters represent knowledge gained during the training of the first machine learning model for data matching. At block 706, the trained parameters of the first machine learning model are transferred to a second machine learning model. At block 708, the second machine learning model with the trained parameters is trained for data matching using a target dataset to derive a deduplication machine learning model, which fine-tunes the first machine learning model. At block 710, the deduplication machine learning model is applied on the target records to classify the target records as duplicate target records and nonduplicate target records.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for deduplicating target records using machine learning, the method comprising:
training a first machine learning model for data matching using a generic dataset;
saving trained parameters of the first machine learning model, the trained parameters representing knowledge gained during the training of the first machine learning model for data matching;
transferring the trained parameters of the first machine learning model to a second machine learning model;
training the second machine learning model with the trained parameters for data matching using a target dataset to derive a deduplication machine learning model; and
applying the deduplication machine learning model on the target records to classify the target records as duplicate target records and nonduplicate target records.

2. The method of claim 1, wherein the first and second machine learning models are first and second deep neural networks and wherein the trained parameters of the first machine learning model are weights of hidden layers of the first deep neural network.

3. The method of claim 2, wherein training the second machine learning model with the trained parameters for data matching includes freezing some of hidden layers of the second deep neural network with the trained parameters transferred from the first deep neural network and then training the second deep neural network with frozen hidden layers and at least one unfrozen hidden layer using the target dataset.

4. The method of claim 3, wherein training the second machine learning model with the trained parameters for data matching further includes unfreezing the frozen hidden layers of the second deep neural network and then training the second deep neural network again using the target dataset.

5. The method of claim 4, wherein training the second deep neural network again using the target dataset includes training the second deep neural network with a slower learning rate using the target dataset than the training of the second deep neural network with the frozen hidden layers and at least one unfrozen hidden layer using the target dataset.

6. The method of claim 1, further comprising processing the target records using a data cleaning tool to determine the target records as labeled and unlabeled target records, the labeled target records being the target records that are determined to be duplicate and nonduplicate target records with associated confidence probability scores above a threshold, the unlabeled target records being the target records that are not determined to be the duplicate and nonduplicate target records with the associated confidence probability scores above the threshold, the target records processed by the deduplication machine learning model being the unlabeled target records from the data cleaning tool.

7. The method of claim 1, wherein applying the deduplication machine learning model on the target records to classify the target records as duplicate and nonduplicate target records includes associating machine learning confidence probability scores to the duplicate and nonduplicate target records, and wherein the duplicate and nonduplicate target records with the machine learning confidence probability scores below a threshold are identified to be manually processed.

8. The method of claim 1, wherein the target records are customer records for at least one business entity and wherein the generic dataset includes noncustomer records.

9. A non-transitory computer-readable storage medium containing program instructions for deduplicating target records using machine learning, wherein execution of the program instructions by one or more processors of a computer system causes the one or more processors to perform steps comprising:
training a first machine learning model for data matching using a generic dataset;
saving trained parameters of the first machine learning model, the trained parameters representing knowledge gained during the training of the first machine learning model for data matching;
transferring the trained parameters of the first machine learning model to a second machine learning model;
training the second machine learning model with the trained parameters for data matching using a target dataset to derive a deduplication machine learning model; and
applying the deduplication machine learning model on the target records to classify the target records as duplicate target records and nonduplicate target records.

10. The computer-readable storage medium of claim 9, wherein the first and second machine learning models are first and second deep neural networks and wherein the trained parameters of the first machine learning model are weights of hidden layers of the first deep neural network.

11. The computer-readable storage medium of claim 10, wherein training the second machine learning model with the trained parameters for data matching includes freezing some of hidden layers of the second deep neural network with the trained parameters transferred from the first deep neural network and then training the second deep neural network with frozen hidden layers and at least one unfrozen hidden layer using the target dataset.

12. The computer-readable storage medium of claim 11, wherein training the second machine learning model with the trained parameters for data matching further includes unfreezing the frozen hidden layers of the second deep neural network and then training the second deep neural network again using the target dataset.

13. The computer-readable storage medium of claim 12, wherein training the second deep neural network again using the target dataset includes training the second deep neural network with a slower learning rate using the target dataset than the training of the second deep neural network with the frozen hidden layers and at least one unfrozen hidden layer using the target dataset.

14. The computer-readable storage medium of claim 9, wherein the steps further comprise processing the target records using a data cleaning tool to determine the target records as labeled and unlabeled target records, the labeled target records being the target records that are determined to be duplicate and nonduplicate target records with associated confidence probability scores above a threshold, the unlabeled target records being the target records that are not determined to be the duplicate and nonduplicate target records with the associated confidence probability scores above the threshold, the target records processed by the deduplication machine learning model being the unlabeled target records from the data cleaning tool.

15. The computer-readable storage medium of claim 9, wherein applying the deduplication machine learning model on the target records to classify the target records as duplicate or nonduplicate target records includes associating machine learning confidence probability scores to the duplicate or nonduplicate target records, and wherein the duplicate or nonduplicate target records with the machine learning confidence probability scores below a threshold are identified to be manually processed.

16. The computer-readable storage medium of claim 9, wherein the target records are customer records for at least one business entity and wherein the generic dataset includes noncustomer records.

17. A system for deduplicating target records using machine learning comprising:
memory; and
at least one processor configured to:
train a first machine learning model for data matching using a generic dataset;
save trained parameters of the first machine learning model, the trained parameters representing knowledge gained during the training of the first machine learning model for data matching;
transfer the trained parameters of the first machine learning model to a second machine learning model;
train the second machine learning model with the trained parameters for data matching using a target dataset to derive a deduplication machine learning model; and
apply the deduplication machine learning model on the target records to classify the target records as duplicate target records and nonduplicate target records.

18. The system of claim 17, wherein the first and second machine learning models are first and second deep neural networks and wherein the trained parameters of the first machine learning model are weights of hidden layers of the first deep neural network.

19. The system of claim 18, wherein the at least one processor is configured to freeze some of hidden layers of the second deep neural network with the trained parameters transferred from the first deep neural network and then train the second deep neural network with frozen hidden layers and at least one unfrozen hidden layer using the target dataset.

20. The system of claim 19, wherein the at least one processor is further configured to unfreeze the frozen hidden layers of the second deep neural network and then train the second deep neural network again using the target dataset.
